(19) United States
(12) Patent Application Publication
(10) Pub. No.: US 2006/0237957 A1
(43) Pub. Date: Oct. 26, 2006

(54) Sealed cushion

(75) Inventor: Mark C. Woydick, Lake Orion, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/111,839

(22) Filed: Apr. 22, 2005

(51) Int. Cl. B60R 21/16

(52) U.S. Cl. 280/743.1; 428/102

(57) ABSTRACT

A sealed cushion construction for an airbag for protecting the occupants of a vehicle during a collision. The construction may include at least two fabric panels that are connected by a seam that may be composed of an adhesive/sealant material. The seam may include sewing to reinforce the seam. Placement of the sewing within the boundaries of the seam may be designed to provide strength to the seam. The seam may have sewing along 100% of the length of the seam, less than 100% of the length of the seam, or not have any sewing along its length.

### BACKGROUND

The present invention relates to a seal construction for a cushion for protecting an occupant of a vehicle during a collision. The present invention further relates to a seal construction for a side airbag curtain.

In a conventional cushion design used for rollover airbag application, a variety of means are used to ensure that the cushion chambers retain pressure over a period of time ranging from 1 to 10 seconds after an inflator has caused deployment. Conventional designs often use one-piece woven technology and may use sewn seams to form airbag chambers. Sewn airbag cushions, because of their inherent design, will not retain inflation gas pressure for an extended period of time. In this situation, an extended period of time may range from about 1 second to 10 seconds or more from the time the cushion has reached maximum pressure. Typical rollover airbag performance requirements necessitate retention of 50% to 70% of a cushion peak pressure over an extended period of time.

### SUMMARY OF THE INVENTION

It is an object of the present invention to provide a sealed cushion construction that includes two or more cut fabric panels that are joined with an adhesive/sealant material to form one or more air retention chambers. It is a further object of the present invention to provide an adhesive/sealant between fabric layers that will enclose all air retention chambers so that a sealed cushion assembly can be created that will have enhanced air retention properties. It is a further object of the present invention to provide a seal construction that allows improved design and manufacturing flexibility.

An airbag according to the present invention includes at least two fabric panels, a seam connecting the fabric panels, wherein the seam is composed of an adhesive/sealant material and the seam separates a gas retention chamber on one side of the seam and a non-gas retention area, non-inflatable region, or outer edge of the airbag on another side of the seam, and sewing disposed within the boundaries of the seam for reinforcing the seam.

According to another embodiment of the present invention, an airbag includes at least two fabric panels, a seam connecting the fabric panels, wherein the seam is composed of an adhesive/sealant material and the seam separates a gas retention chamber on one side of the seam and a non-gas retention area, non-inflatable region, or outer edge of the airbag on another side of the seam, and a plurality of sewings disposed within the boundaries of the seam for reinforcing the seam, wherein the sewings are disposed with the boundaries of the seam so that the median of the sewing positions is no closer to a boundary of the gas retention chamber 50% of the width of the seam, and no closer to a boundary of the non-gas retention area, non-inflatable region, or outer edge than 10% of the width of the seam.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a sectional view of an airbag and seal design according to an embodiment of the present invention.

FIG. 2 is a sectional view of an airbag and seal design according to an embodiment of the present invention.

FIG. 3 is a sectional view of an airbag and seal design according to an embodiment of the present invention.

FIG. 4 is a top view of a seal design according to an embodiment of the present invention.

FIG. 5 is a top view of a seal design according to an embodiment of the present invention.

FIG. 6 is a top view of a seal design according to an embodiment of the present invention.

FIG. 7 is a top view of a seal design according to an embodiment of the present invention.

FIG. 8 is a top view of a seal design according to an embodiment of the present invention.

FIG. 9 is a top view of a seal design according to an embodiment of the present invention.

FIG. 10 is a side view of an airbag according to an embodiment of the present invention.

### DETAILED DESCRIPTION

Embodiments of the present invention will be described below with reference to the drawings.

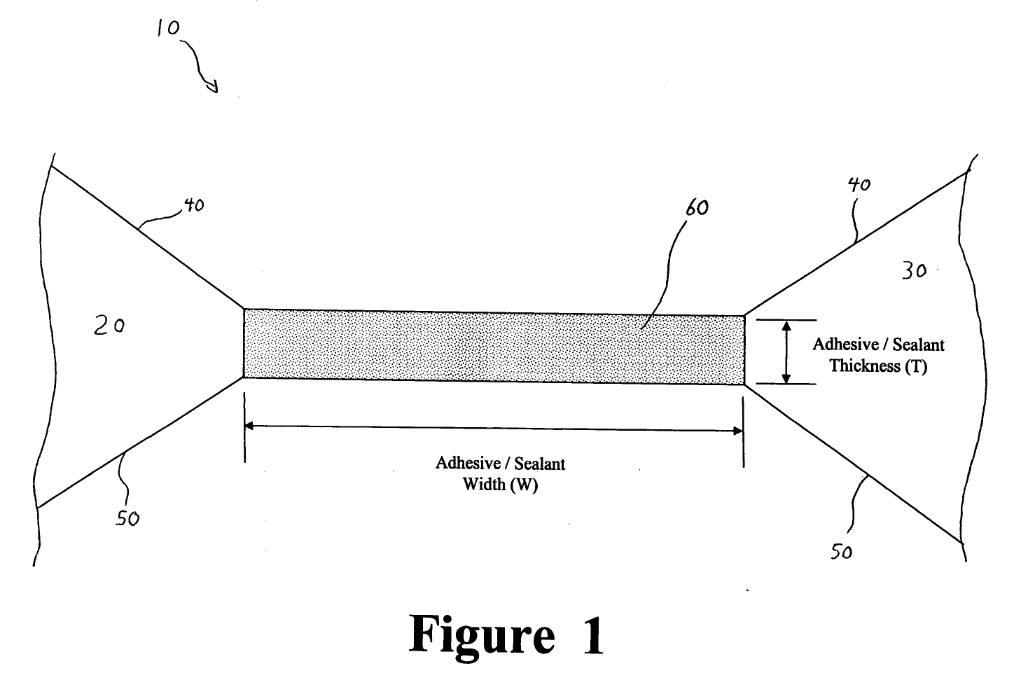

FIG. 1 shows a sectional view of an airbag 10 according to an embodiment of the present invention. In the example shown in FIG. 1, two fabric panels 40, 50 are joined by a seal 60 to form gas retention chambers 20, 30. The seal 60 may be composed of adhesive/sealant materials. Various adhesives and sealant materials may be selected, as known by one of ordinary skill in the art, to form a seam that joins two or more fabric panels together to form one or more gas retention chambers.

For example, a two part RTV (room temperature vulcanizing) material may be used as an adhesive/sealant material to form a seam. Such an adhesive/sealant material may be dispensed as a viscous material onto a fabric panel as a bead that forms an outline of internal and/or external gas retention chambers. A second fabric panel may then be assembled over the dispensed bead and first fabric panel to form a sandwich of fabric, adhesive/sealant material, and fabric, thereby forming an airbag cushion with one or more gas retention chambers. Once this sandwich has been assembled, the assembly may be compressed to distribute the adhesive/sealant material on to both fabric panels. The final shape of the adhesive/sealant material located between the fabric panels is a relatively thin and wide section of adhesive/sealant material.

In the example shown in FIG. 1, the seam 60 of adhesive/sealant material has a width W and a thickness T. In a further embodiment of the present invention, cushion seal has a final width to thickness ratio of 5:1 to 30:1. The ratio of the seam width to the seam thickness may be designed to provide optimal gas retention over an extended period of time.

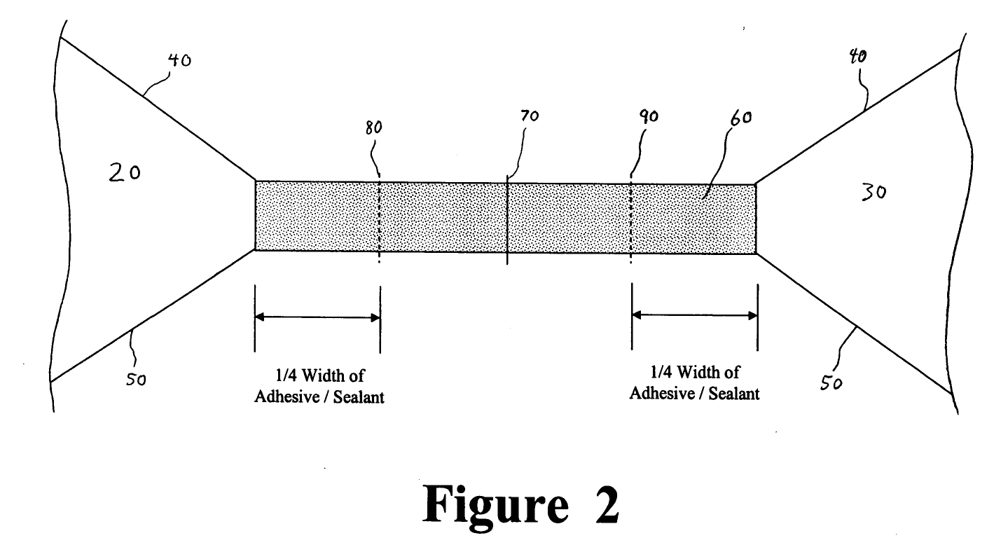

FIG. 2 is a sectional view of an airbag and seal design according to an embodiment of the present invention. In the example shown in FIG. 2, seam 60 of adhesive/sealant material joins two fabric panels 40, 50 to form two gas retention chambers 20, 30 on each side of the seam 60. The cushion is further reinforced by sewing 70 within the seam 60. The sewing 70 provides greater strength to the seam 60 and air retention chambers 20, 30.

In the example shown in FIG. 2, the sewing 70 is placed at the approximate midpoint between the two gas retentions chambers 20, 30 so that the sewing 70 and seam 60 may seal both gas retention chamber 20 and gas retention chamber 30.

In a further embodiment of the present invention, the sewing is placed within the boundaries of the seam 60 of adhesive/sealant material so that the sewing 70 is no closer than ¼ of the width W of the seam 60 to an edge or boundary of the seam 60. In the example shown in FIG. 1, sewing 70 is placed between dashed marks 80, 90, which show a distance of ¼ of the width W of the seam 60 to the edge of the seam 60. Placement of the sewing within the seam may depend upon the gas pressures used with the air retention chambers and the strength required for the seam. Further, some deformation or elongation of the adhesive/sealant material may be allowed as a means to absorb energy during inflation of the airbag. Placement of the sewing may also be designed to control this energy absorption by placing the sewing closer to or further away from seam areas that may deform or elongate during airbag deployment. Placement of the sewing may further be designed to provide a required or acceptable performance while providing manufacturing efficiency.

In a further embodiment of the present invention, the sewing 70 is placed within the boundaries of the seam 60 so that the sewing is no closer than ⅓ of the width W to an edge or boundary of the seam 60.

The sewing 70 may include one or more lines of sewing. In an embodiment of the present invention, the sewing 70 includes one line of sewing.

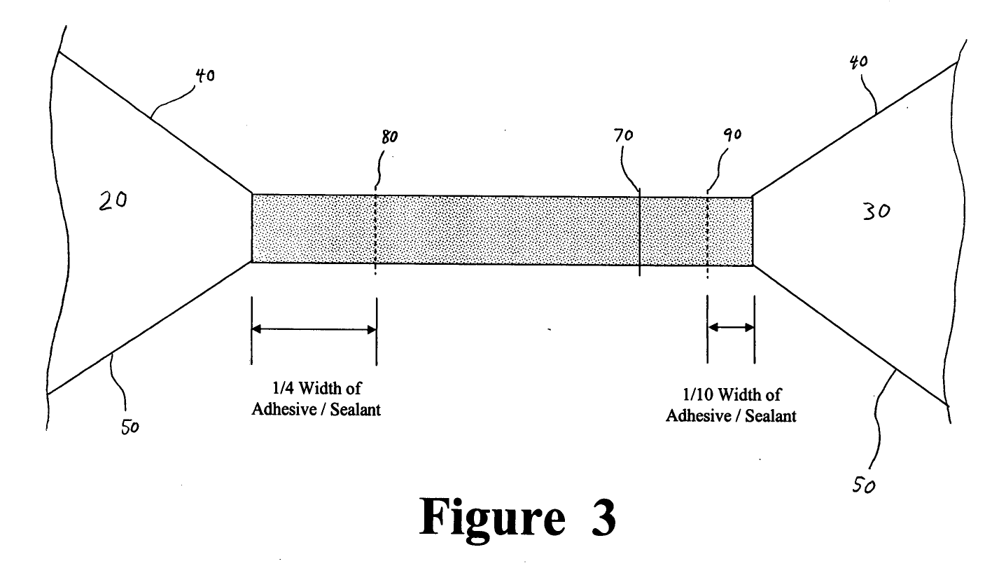

FIG. 3 shows a sectional view of a an airbag and seal design according to an embodiment of the present invention. In the example shown in FIG. 3, 20 denotes a chamber that is designed to retain gas while 30 denotes a non-gas retention area or non-inflatable region. In another example, 30 may instead denote the outside edge of the airbag. In the example shown in FIG. 3, the sewing 70 is placed within the boundaries of seam 60 so that it is no closer to the boundary of the gas retention chamber 20 than ¼ of the width W of the seam 60 and no closer to the boundary of the non-gas retention area, non-inflatable region, or outer edge 30 than 1/10 of the width of the seam. In the example shown in FIG. 3, sewing 70 is placed between dashed marks 80, 90, which respectively show a distance of ¼ of the width W of the seam 60 to edge of the seam 60 with gas retention chamber 20 and a distance of 1/10 of the width W of the seam 60 to the edge of the seam 60 with non-gas retention area, non-inflatable region or outer edge of the airbag.

Placement of the sewing within the seam may depend upon the gas pressures used with the air retention chamber and the strength required for the seam. Further, some deformation or elongation of the adhesive/sealant material may be allowed as a means to absorb energy during inflation of the airbag. Placement of the sewing may also be designed to control this energy absorption by placing the sewing closer to or further away from seam areas that may deform or elongate during airbag deployment. For example, the sewing 70 may be placed closer to the boundary of the seam 60 with the non-gas retention area, non-inflatable region, or outside edge of the airbag, to control energy absorption during airbag deployment, as shown in FIG. 3. In a further example, placement of the sewing 70 may further be designed to provide a required or acceptable performance while providing manufacturing efficiency.

In a further embodiment of the present invention, the sewing 70 is placed within the boundaries of the seam 60 so that the sewing is no closer than ½ of the width W to an edge or boundary of the seam 60 with gas retention chamber 20 and a distance of 1/10 of the width W of the seam 60 to the edge of the seam 60 with non-gas retention area, non-inflatable region, or the outside edge of the airbag. More preferably, the sewing is placed within the boundaries of the seam 60 so that the sewing is no closer than 60% of the width W to an edge or boundary of the seam 60 with gas retention chamber 20 and a distance of 10% of the width W of the seam 60 to the edge of the seam 60 with non-gas retention area, non-inflatable region, or the outside edge of the airbag. More preferably, the sewing is placed within the boundaries of the seam 60 so that the sewing is no closer than 70% of the width W to an edge or boundary of the seam 60 with gas retention chamber 20 and a distance of 10% of the width W of the seam 60 to the edge of the seam 60 with non-gas retention area, non-inflatable region, or the outside edge of the airbag. More preferably, the sewing is placed within the boundaries of the seam 60 so that the sewing is no closer than 80% of the width W to an edge or boundary of the seam 60 with gas retention chamber 20 and a distance of 10% of the width W of the seam 60 to the edge of the seam 60 with non-gas retention area, non-inflatable region, or the outside edge of the airbag. Even more preferably, the sewing is placed within the boundaries of the seam 60 so that the sewing is no closer than 90% of the width W to an edge or boundary of the seam 60 with gas retention chamber 20 and a distance of 10% of the width W of the seam 60 to the edge of the seam 60 with non-gas retention area, non-inflatable region, or the outside edge of the airbag.

In a further embodiment of the present invention, the sewing 70 is placed within the boundaries of the seam 60 so that the sewing is no closer than 50% of the width W to an edge or boundary of the seam 60 with gas retention chamber 20 and a distance of 20% of the width W of the seam 60 to the edge of the seam 60 with non-gas retention area, non-inflatable region, or the outside edge of the airbag. More preferably, the sewing 70 is placed within the boundaries of the seam 60 so that the sewing is no closer than 60% of the width W to an edge or boundary of the seam 60 with gas retention chamber 20 and a distance of 20% of the width W of the seam 60 to the edge of the seam 60 with non-gas retention area, non-inflatable region, or the outside edge of the airbag. More preferably, the sewing 70 is placed within the boundaries of the seam 60 so that the sewing is no closer than 70% of the width W to an edge or boundary of the seam 60 with gas retention chamber 20 and a distance of 20% of the width W of the seam 60 to the edge of the seam 60 with non-gas retention area, non-inflatable region, or the outside edge of the airbag.

In a further embodiment of the present invention, the sewing 70 is placed within the boundaries of the seam 60 so that the sewing is no closer than 50% of the width W to an edge or boundary of the seam 60 with gas retention chamber 20 and a distance of 30% of the width W of the seam 60 to the edge of the seam 60 with non-gas retention area, non-inflatable region, or the outside edge of the airbag. More preferably, the sewing 70 is placed within the boundaries of the seam 60 so that the sewing is no closer than 60% of the width W to an edge or boundary of the seam 60 with gas retention chamber 20 and a distance of 30% of the width W of the seam 60 to the edge of the seam 60 with non-gas retention area, non-inflatable region, or the outside edge of the airbag.

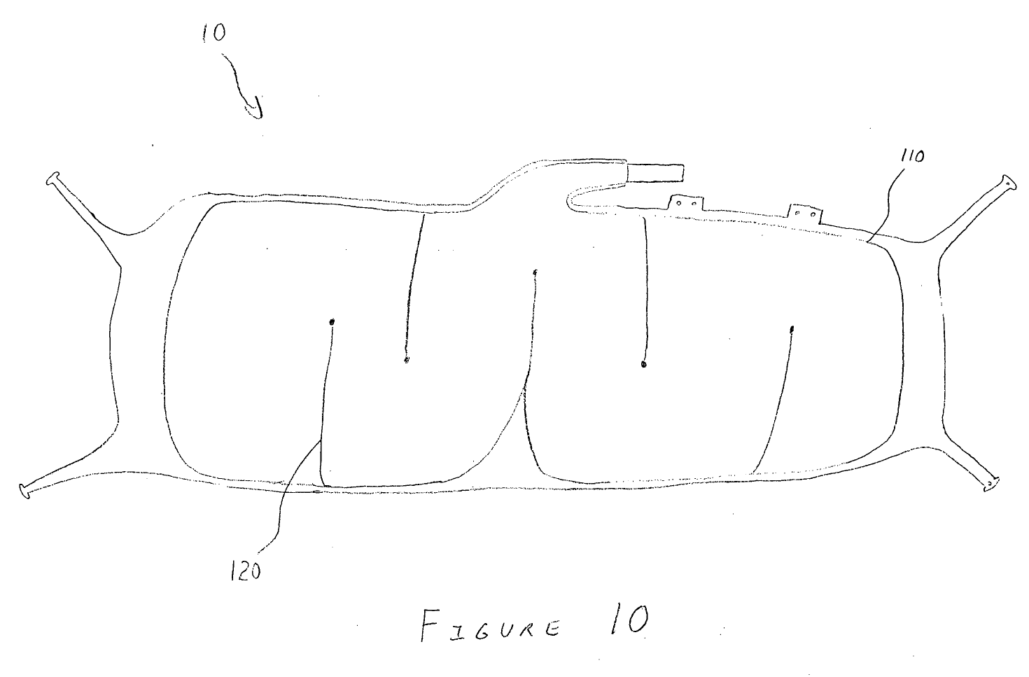

Placement of the sewing 70 within the seam 60 may also depend on whether the seam 60 is the seam at the outer edge of the airbag or if the seam is an internal seam that is contained with the airbag. For example, the seam may compose an exterior seam 110 or an interior seam 120 of an airbag, as shown in FIG. 10.

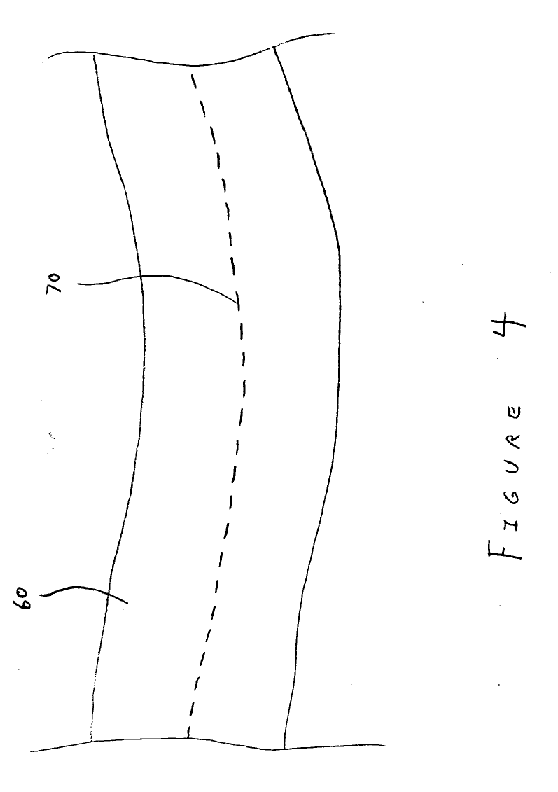

FIG. 4 shows a view of an embodiment of the present invention in which an airbag cushion includes a seam 60 with sewing 70. The seam 60 may be composed of adhesive/sealant material that is reinforced by the sewing 70. In the example shown in FIG. 4, the sewing 70 is disposed along 100% of the length of the seam 60 to reinforce the seam 60.

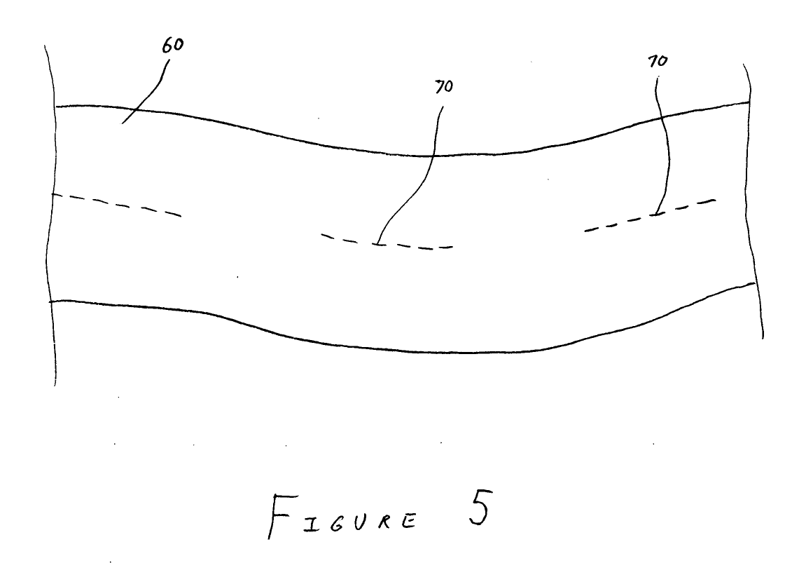

FIG. 5 shows a view of an embodiment of the present invention in which an airbag cushion includes a seam 60 with sewing 70. The seam 60 may be composed of adhesive/sealant material that is reinforced by the sewing 70. In the example shown in FIG. 5, the sewing 70 is disposed along less than 100% of the length of the seam 60. In the example shown in FIG. 5, the sewing 70 is designed to reinforce the seam 60 in an efficient way by disposing the sewing 70 along less than 100% of the length of the seam 60. The amount of sewing 70 along the length of seam 60 may chosen to provide sufficient strength while providing manufacturing efficiency. The amount of sewing 70 along the length of seam 60 may also depend upon whether the seam 60 is the seam at the outer edge of an airbag or if the seam is an internal seam that is contained with the outer edge of an airbag.

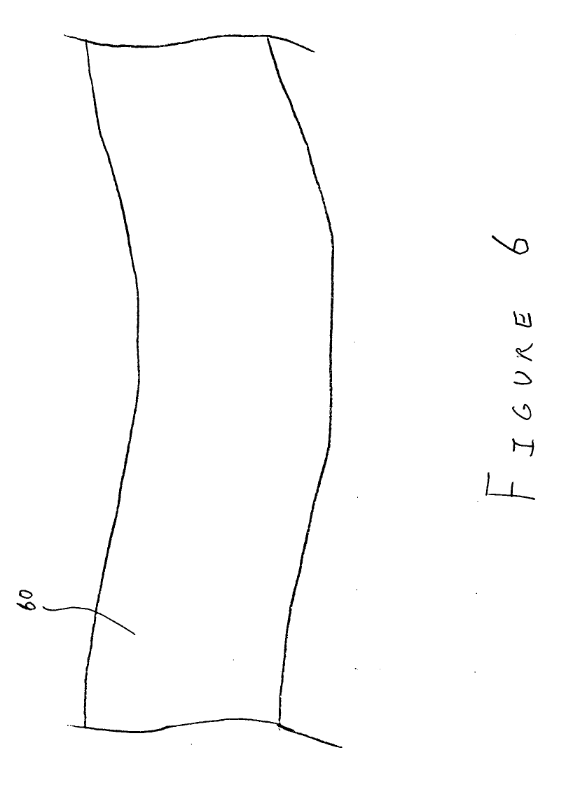

FIG. 6 shows a view of an embodiment of the present invention in which an airbag cushion includes a seam 60. The seam 60 may be composed of adhesive/sealant material that is not reinforced by the sewing. This seam may be used to provide strength for cushions while also providing manufacturing efficiency. Such seams may be used as the seam at the outer edge of an airbag or for seams that are internal and contained within an airbag.

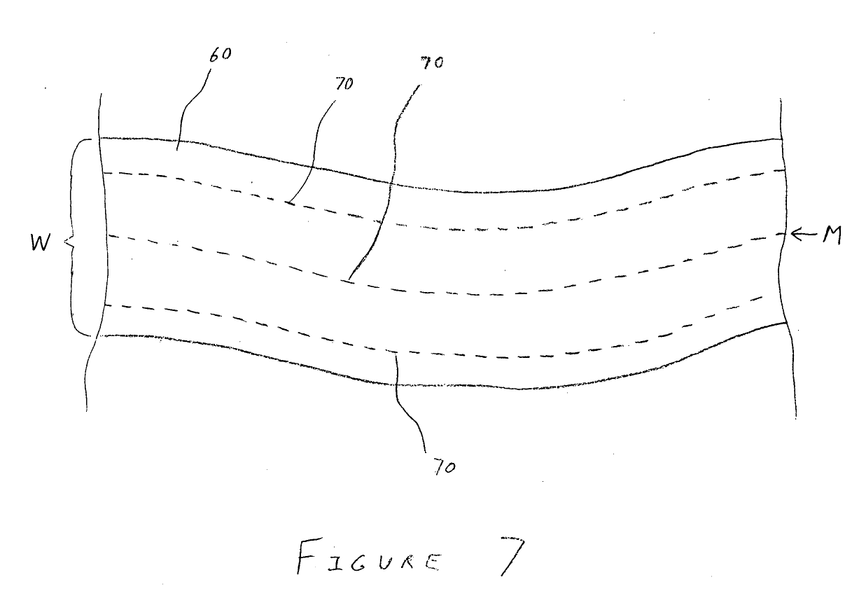

Another embodiment of the present invention is shown by a top view in FIG. 7. In this example, three sewings 70 are disposed with the seam 60. The width of the seam W is also indicated in FIG. 7. A median M of the position of the sewings 70 is also indicated. In the example shown in FIG. 7, the sewings 70 are uniformly distributed across the width W, causing the median M to be located at the center of the width W.

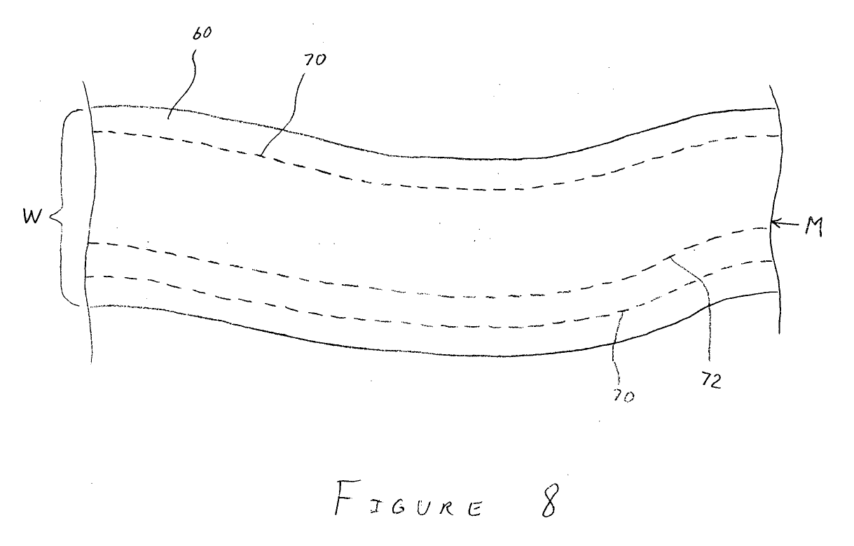

FIG. 8 shows another embodiment of the present invention in which a sewing 72 is placed off-center of the middle of the seam 60 so that the sewing 72 is closer to one sewing than another. This causes the median M of the positions of the sewings to shift off-center as well, as indicated in FIG. 8.

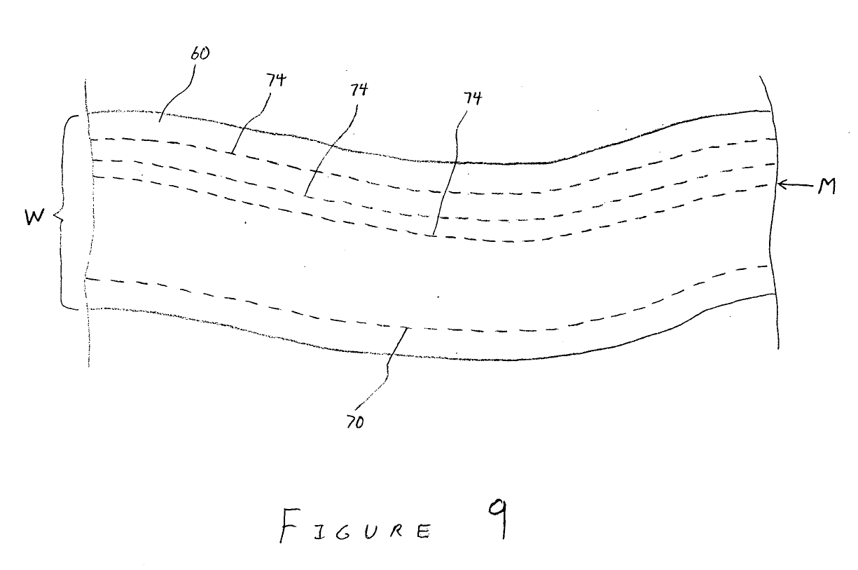

FIG. 9 shows another embodiment of the present invention in which multiple sewings 74 are placed to one side of the seam 60. Because of the positioning of sewings 74, median M is shifted off-center towards the position of multiple sewings 74.

In a further embodiment of the present invention, the sewings are placed within the boundaries of the seam 60 so that the median M of the sewing positions is no closer than 50% of the width W to an edge or boundary of the seam 60 with gas retention chamber 20 and a distance of 10% of the width W of the seam 60 to the edge of the seam 60 with non-gas retention area, non-inflatable region, or the outside edge of the airbag. More preferably, the sewings are placed within the boundaries of the seam 60 so that the median M of the sewing positions is no closer than 60% of the width W to an edge or boundary of the seam 60 with gas retention chamber 20 and a distance of 10% of the width W of the seam 60 to the edge of the seam 60 with non-gas retention area, non-inflatable region, or the outside edge of the airbag. More preferably, the sewings are placed within the boundaries of the seam 60 so that the median M of the sewing positions is no closer than 70% of the width W to an edge or boundary of the seam 60 with gas retention chamber 20 and a distance of 10% of the width W of the seam 60 to the edge of the seam 60 with non-gas retention area, non-inflatable region, or the outside edge of the airbag. More preferably, the sewings are placed within the boundaries of the seam 60 so that the median M of the sewing positions is no closer than 80% of the width W to an edge or boundary of the seam 60 with gas retention chamber 20 and a distance of 10% of the width W of the seam 60 to the edge of the seam 60 with non-gas retention area, non-inflatable region, or the outside edge of the airbag. Even more preferably, the sewings are placed within the boundaries of the seam 60 so that the median M of the sewing positions is no closer than 90% of the width W to an edge or boundary of the seam 60 with gas retention chamber 20 and a distance of 10% of the width W of the seam 60 to the edge of the seam 60 with non-gas retention area, non-inflatable region, or the outside edge of the airbag.

In a further embodiment of the present invention, the sewings are placed within the boundaries of the seam 60 so that the median M of the sewing positions is no closer than 50% of the width W to an edge or boundary of the seam 60 with gas retention chamber 20 and a distance of 20% of the width W of the seam 60 to the edge of the seam 60 with non-gas retention area, non-inflatable region, or the outside edge of the airbag. More preferably, the sewings are placed within the boundaries of the seam 60 so that the median M of the sewing positions is no closer than 60% of the width W to an edge or boundary of the seam 60 with gas retention chamber 20 and a distance of 20% of the width W of the seam 60 to the edge of the seam 60 with non-gas retention area, non-inflatable region, or the outside edge of the airbag. More preferably, the sewings are placed within the boundaries of the seam 60 so that the median M of the sewing positions is no closer than 70% of the width W to an edge or boundary of the seam 60 with gas retention chamber 20 and a distance of 20% of the width W of the seam 60 to the edge of the seam 60 with non-gas retention area, non-inflatable region, or the outside edge of the airbag.

In a further embodiment of the present invention, the sewings ares placed within the boundaries of the seam 60 so that the median M of the sewing positions is no closer than 50% of the width W to an edge or boundary of the seam 60 with gas retention chamber 20 and a distance of 30% of the width W of the seam 60 to the edge of the seam 60 with non-gas retention area, non-inflatable region, or the outside edge of the airbag. More preferably, the sewings are placed within the boundaries of the seam 60 so that the median M of the sewing positions is no closer than 60% of the width W to an edge or boundary of the seam 60 with gas retention chamber 20 and a distance of 30% of the width W of the seam 60 to the edge of the seam 60 with non-gas retention area, non-inflatable region, or the outside edge of the airbag.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag, comprising:
at least two fabric panels;
a seam connecting the fabric panels, wherein the seam is composed of an adhesive/sealant material and the seam separates a gas retention chamber on one side of the seam and a non-gas retention area, non-inflatable region, or outer edge of the airbag on another side of the seam; and
sewing disposed within the boundaries of the seam for reinforcing the seam, wherein the sewing is disposed with the boundaries of the seam so that the sewing is no closer to a boundary of the gas retention chamber 50% of the width of the seam, and no closer to a boundary of the non-gas retention area, non-inflatable region, or outer edge than 10% of the width of the seam.

2. The airbag of claim 1, wherein the sewing is disposed with the boundaries of the seam so that the sewing is no closer to a boundary of the gas retention chamber than 60% of the width of the seam, and no closer to a boundary of the non-gas retention area, non-inflatable region, or outer edge than 10% of the width of the seam.

3. The airbag of claim 1, wherein the sewing is disposed with the boundaries of the seam so that the sewing is no closer to a boundary of the gas retention chamber than 70% of the width of the seam, and no closer to a boundary of the non-gas retention area, non-inflatable region, or outer edge than 10% of the width of the seam.

4. The airbag of claim 1, wherein the sewing is disposed with the boundaries of the seam so that the sewing is no closer to a boundary of the gas retention chamber than 60% of the width of the seam, and no closer to a boundary of the non-gas retention area, non-inflatable region, or outer edge than 20% of the width of the seam.

5. The airbag of claim 1, wherein the sewing is disposed along 100% of the length of the seam.

6. The airbag of claim 1, wherein the sewing is disposed along 0% to less than 100% of the length of the seam.

7. The airbag of claim 1, wherein the seam forms an outer seam or outer edge of the airbag.

8. The airbag of claim 1, wherein the seam is contained within an outer edge or boundary of the airbag.

9. An airbag, comprising:
at least two fabric panels;
a seam connecting the fabric panels, wherein the seam is composed of an adhesive/sealant material and the seam separates a gas retention chamber on one side of the seam and a non-gas retention area, non-inflatable region, or outer edge of the airbag on another side of the seam; and
a plurality of sewings disposed within the boundaries of the seam for reinforcing the seam, wherein the sewings are disposed with the boundaries of the seam so that the median of the sewing positions is no closer to a boundary of the gas retention chamber 50% of the width of the seam, and no closer to a boundary of the non-gas retention area, non-inflatable region, or outer edge than 10% of the width of the seam.

10. The airbag of claim 9, wherein the sewings are disposed with the boundaries of the seam so that the median is no closer to a boundary of the gas retention chamber than 60% of the width of the seam, and no closer to a boundary of the non-gas retention area, non-inflatable region, or outer edge than 10% of the width of the seam.

11. The airbag of claim 9, wherein the sewings are disposed with the boundaries of the seam so that the median is no closer to a boundary of the gas retention chamber than 70% of the width of the seam, and no closer to a boundary of the non-gas retention area, non-inflatable region, or outer edge than 10% of the width of the seam.

12. The airbag of claim 9, wherein the sewings are disposed with the boundaries of the seam so that the median is no closer to a boundary of the gas retention chamber than 60% of the width of the seam, and no closer to a boundary of the non-gas retention area, non-inflatable region, or outer edge than 20% of the width of the seam.
